(19) United States
(12) Patent Application Publication
(10) Pub. No.: US 2007/0182853 A1
(43) Pub. Date: Aug. 9, 2007

(54) Information processing apparatus and display controlling method applied to the same

(76) Inventor: Hirofumi Nishikawa, Akishima-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/702,750

(22) Filed: Feb. 6, 2007

(30) Foreign Application Priority Data
Feb. 7, 2006 (JP) 2006-030198

(51) Int. Cl. H04N 3/27; G06F 3/00

(52) U.S. Cl. 348/554; 715/718

(57) ABSTRACT

According to one embodiment, an information processing apparatus including a built-in display device configured to display picture data on full screen, a display controller configured to generate a picture signal and output the generated picture signal to an external display device, picture signal processing unit for executing picture quality processing for the picture signal generated by the display controller, and input unit for inputting a mode of allowing the built-in display device to display a first picture and allowing the external display device to display second picture data different from the first picture data.

### CROSS-REFERENCE TO RELATED APPLICATIONS

This application is based upon and claims the benefit of priority from Japanese Patent Application No. 2006-030198, filed Feb. 7, 2006, the entire contents of which are incorporated herein by reference.

### BACKGROUND

1. Field

One embodiment of the invention relates to an information processing apparatus capable of displaying moving picture data on a built-in display unit and a display controlling method applied to the information processing apparatus.

2. Description of the Related Art

In general, notebook-type personal computers having the same AV (audio-video) reproducing function as that of AV devices such as DVD (digital versatile disc) players, TV devices, etc.

For example, Jpn. Pat. Appln. KOKAI Publication No. 2005-77501 discloses a personal computer equipped with a DVD drive and a TV tuner. In the computer disclosed in Jpn. Pat. Appln. KOKAI Publication No. 2005-77501, moving picture data recorded by the TV tuner are processed by a picture controller and displayed on a built-in liquid crystal display unit connected directly to the picture controller.

Incidentally, to display sufficiently high-quality moving picture data obtained by the DVD drive and the TV tuner, a function of executing a picture signal processing to enhance the picture quality of the moving pictures is required. In addition, methods of using multi-monitors outputting the picture signals to an externally connected CRT or TV besides the built-in liquid crystal display unit have increased. In the case of using the multi-monitors, different contents are displayed on the built-in liquid crystal display unit and the externally connected CRT (or TV) and both the monitors are used.

According to Jpn. Pat. Appln. KOKAI Publication No. 2005-77501, however, the picture signal processing for enhancing the picture quality of the moving pictures does not correspond to the use of the multi-monitors. When the built-in liquid crystal display unit is used as a multi-monitor, the picture signal processing for enhancing the picture quality of the moving pictures cannot be executed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing an outer appearance of a computer according to an embodiment of the present invention;

FIG. 2 is a block diagram showing a system configuration of the computer shown in FIG. 1 according to an embodiment;

FIG. 3 is a block diagram showing a configuration of a picture quality enhancing engine provided in the computer shown in FIG. 1 according to an embodiment;

FIG. 4 is an illustration showing combined display methods of a built-in LCD, and CRT and TV serving as external outputs according to an embodiment; and

FIG. 5 is a flowchart showing blocks of a display control processing executed in the computer shown in FIG. 1 according to an embodiment of the invention.

### DETAILED DESCRIPTION

Various embodiments according to the invention will be described hereinafter with reference to the accompanying drawings. In general, according to one embodiment of the invention, an information processing apparatus comprising a built-in display device configured to display picture data on full screen, a display controller configured to generate a picture signal and output the generated picture signal to an external display device, picture signal processing means for executing picture quality processing for the picture signal generated by the display controller, and input means for inputting a mode of allowing the built-in display device to display a first picture and allowing the external display device to display second picture data different from the first picture data. The built-in display device is a display device configured to display on full screen picture data formed in accordance with the picture signal subjected to picture quality processing by the picture signal processing means if the mode is input by the input means.

An embodiment of the present invention is described with reference to the drawings.

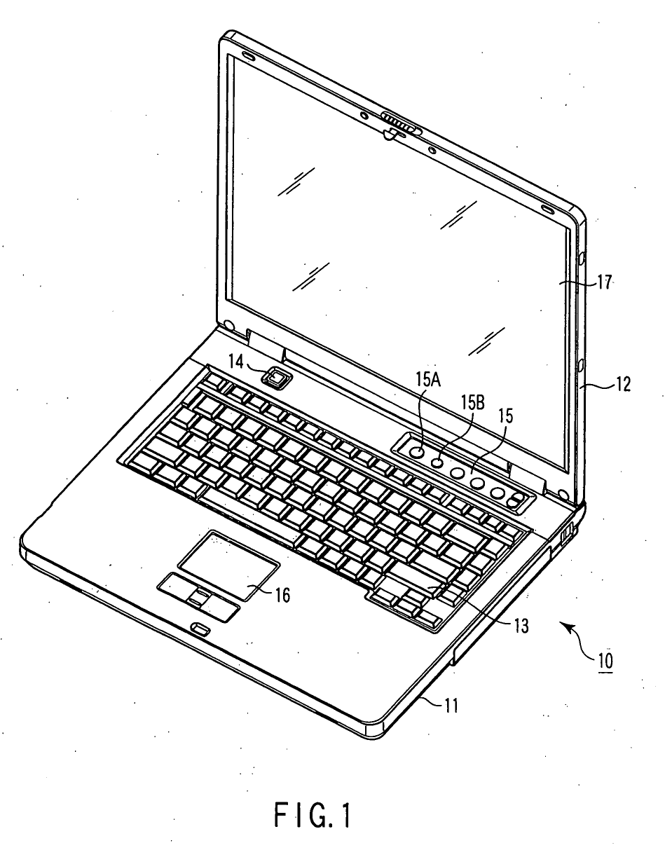

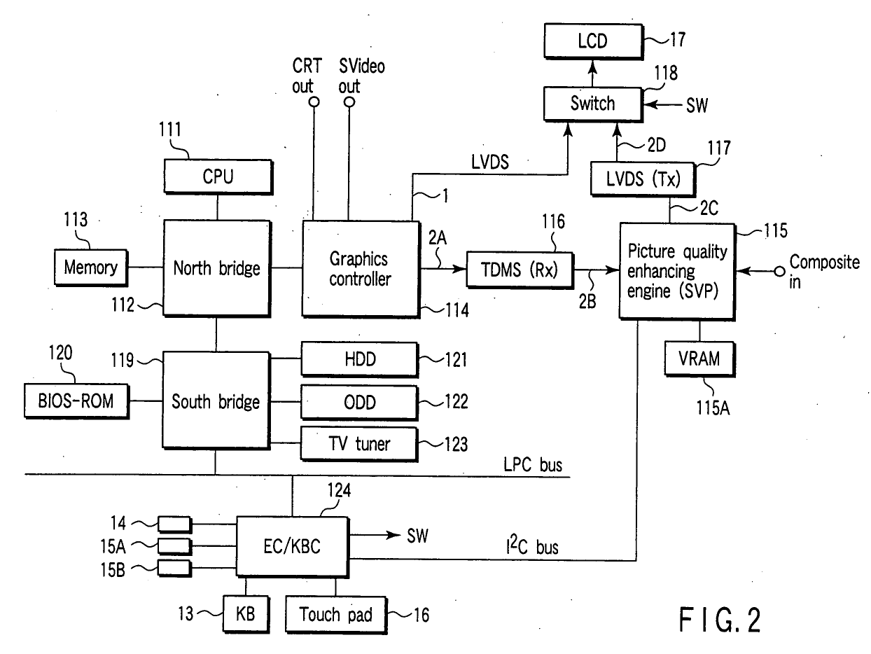

First, a configuration of an information processing apparatus according to the embodiment of the present invention is described with reference to FIG. 1 and FIG. 2. The information processing apparatus is implemented as, for example, a notebook-type personal computer 10.

FIG. 1 is a perspective view of a notebook-type personal computer 10 with its display unit opened. The computer 10 is composed of a computer body 11 and the display unit 12. A built-in display device composed of an LCD (Liquid Crystal Display) 17 is embedded in the display unit 12. A display screen of the LCD 17 is located approximately at the center of the display unit 12.

The display unit 12 is attached to the computer body 11 so as to freely pivot between an opened position and a closed position. The computer body 11 has a housing shaped in a thin box, and comprises on its top face a keyboard 13, a power button 14 for power-on/power-off of the computer 10, an input operation panel 15, a touch pad 16, etc. Output terminals for an external display device (not shown) are provided on a rear face of the computer body 11. The output terminals are, for example, VGA output terminals outputting signals to a CRT, S terminals outputting signals to the TV, etc.

The input operation panel 15 is an input device inputting events corresponding to pushed buttons, and comprises a plurality of buttons to start a plurality of functions, respectively. The button group includes, for example, a TV start button 15A, a DVD/CD start button 15B, etc. The TV start button 15A is a button for reproduction of TV broadcast program data. When the user pushes down the TV start button 15A, an application program for reproduction of TV broadcast program data is automatically started. The DVD/CD start button 15B is a button for reproduction of contents such as video, music, etc. recorded on DVD or CD. When the user pushes down the DVD/CD start button 15B, an application program for reproduction of the contents is automatically started.

To display on the LCD 17 the TV broadcast program data and the moving picture data such as the video contents, with high quality, the computer 10 of this embodiment has a function of automatically enhancing the picture quality of the moving picture data at the time of reproducing the moving picture data.

Next, the system configuration of the computer 10 is described.

As shown in FIG. 2, the computer 10 comprises a CPU (discriminating means) 111, a north bridge 112, a main memory 113, a graphics controller (display controller) 114, a picture quality enhancing engine (HVE: Super Video Processor: picture processing means) 115, a TMDS (Rx) processor 116, an LVDS (Tx) processor 117, a switch 118, a south bridge 119, a BIOS-ROM 120, a hard disk drive (HDD) 121, an optical disk drive (ODD) 122,

a TV tuner 123, an embedded controller/keyboard controller IC (EC/KBC) 124, etc.

The CPU 111 is a processor provided to control the operations of the computer 10. The CPU 111 executes the operating system (OS) and various kinds of application programs loaded from the hard disk drive (HDD) 121 to the main memory 113. The OS has, for example, a window system for displaying a plurality of windows on the display screen.

The moving picture data (for example, TV broadcast program data received by the TV tuner 123, video contents stored on memory media such as DVD, etc.) are generally displayed in a window corresponding to a video reproducing application program for reproducing the moving picture data (window display mode). In this case, for example, the window corresponding to the video reproducing application program is arranged on the desktop screen and the moving picture data are displayed in the window (window).

In addition, the computer 10 can also display the moving picture data on the display screen of the LCD 17 by double-click of the moving picture data in the window with a mouse, etc. The input means such as the mouse, pointing device, etc. are means for inputting events for displaying the picture data on the display device in a full-screen mode changed from the window mode, in accordance with the user operations such as the double-click on the picture data.

In the full-screen mode, the moving picture data alone are displayed on the substantially entire area of the display screen. In this case, the desktop screen, and the windows corresponding to the other application programs except the video reproducing application program are not displayed basically. In addition, a menu bar of the window corresponding to the video reproducing application program, but the moving picture data alone are displayed on the substantially entire area of the display screen.

The CPU 111 also executes the system BIOS (Basic Input Output System) stored in the BIOS-ROM 120. The system BIOS is a program for the hardware control.

The north bridge 112 is a bridge device for making a connection between a local bus of the CPU 111 and the south bridge 119. A memory controller for controlling access to the main memory 113 is also built in the north bridge 112. The north bridge 112 also has a function of executing communications with the graphics controller 114 via an AGP (Accelerated Graphics Port) bus, etc.

The graphics controller 114 is a display controller which controls the LCD 17 employed as a display monitor of the computer 10. The graphics controller 114 comprises a video memory (VRAM) to generate picture signals for formation of display images which should be displayed on the LCD 17 from display data drawn in the video memory by the OS/application programs. The display images which should be displayed on the LCD 17 generally include images on the desktop screen and images of the respective windows arranged on the desktop screen. When the moving picture data are displayed in the full-screen mode, however, the display images which should be displayed on the LCD 17 include images of the moving picture data alone. Therefore, when the moving picture data are displayed in the full-screen mode, picture signals for formation of the display images of the moving picture data alone are output from the graphics controller 114.

The picture signals generated by the graphics controller 114 are output to line 1 and line 2A. The picture signals output to the line 1 include, for example, RGB signals in LVDS (Low Voltage Differential Signaling) mode. The picture signals output to the line 2A include, for example, RGB signals in TDMS (Transition DMLow Voltage Differential Signaling) mode. The graphics controller 114 also comprises an interface (CRT out) for outputting the picture signals to the external display device, i.e. CRT (Cathode Ray Tube), and an interface (S Video out) for outputting the picture signals to the TV, etc. via an S video terminal.

When the picture signals are output from these interfaces to the external devices, the external devices connected to the interfaces can also be employed as a multi-monitor (or clone (simultaneous display)). The multi-monitor is a method of allowing two display devices to display different contents and the clone (simultaneous display) is a method of allowing them to simultaneously display the same contents.

The TMDS (Rx) processor 116 converts the TDMS-mode RGB signals transmitted from the graphics controller 114 via the line 2A into digital RGB signals, and transmits the digital RGB signals to the picture quality enhancing engine (HVE) 115 via a line 2B.

The picture quality enhancing engine (HVE) 115 is a picture processing controller which executes the picture processing (hereinafter called picture quality correction) for enhancing the picture quality of the picture signals generated by the graphics controller 114. The picture quality enhancing engine (HVE) 115 comprises a video memory (VRAM) 115A. The picture quality correction is executed in the video memory (VRAM) 115A. The picture quality correction is a picture processing exclusive for moving pictures to enhance the moving picture quality. The picture quality correction is executed to smoothly display the moving pictures on the LCD 17. In the picture quality correction, for example, processings such as color correction, sharpness correction, brightness correction, edge enhancement, etc. are executed to enhance the moving picture quality.

In addition, the picture quality enhancing engine (HVE) 115 can also execute the picture quality correction for the picture signals input from an external video device via a composite input terminal.

The picture signals subjected to the picture quality correction by the picture quality enhancing engine (HVE) 115 are transmitted to the LVDS (Tx) processor 117 via a line 2C. The LVDS (Tx) processor 117 converts the quality-corrected picture signals output from the picture quality enhancing engine (HVE) 115 into the RGB signals of the LVDS (Low Voltage differential Signaling) mode, and outputs the LVDS-mode RGB signals to a line 2D.

Furthermore, the picture quality enhancing engine (HVE) 115 also comprises a scaling function for varying the resolution and the aspect ratio of the picture signals. The scaling of the picture signals is executed after the picture quality correction of the picture signals is executed. The moving pictures can be displayed with high quality by executing the picture quality correction for raw data before scaled and then scaling the picture signals subjected to the picture quality correction, rather than executing the picture quality correction of the scaled picture signals.

The switch 118 functions as a selector for selectively outputting to the LCD 17 the picture signals generated by the graphics controller 114 or the picture signals subjected to the picture quality correction by the picture quality enhancing engine (HVE) 115. The switch 118 comprises a first input terminal connected to the line 1, a second input terminal connected to the line 2D, and an output terminal connected to the LCD 17. The switch 118 is configured to select one of the first input terminal and the second input terminal and connect the selected input terminal to the output terminal, in accordance with a switch control signal SW supplied from the EC/KBC 124. In the present embodiment, two display control modes as described below can be employed by the operation of the switch 118.

(1) Normal mode: In the normal mode, the picture signals from the graphics controller 114 are transmitted tom the LCD 17 not via the picture quality enhancing engine (HVE) 115, but in the path 1 (LVDS) (see FIG. 2). The normal mode is employed when still pictures are included in the display image displayed on the LCD 17. The normal mode is also employed when the display image displayed on the LCD 17 is in the window display mode.

(2) High quality mode: In the high quality mode, the picture signals from the graphics controller 114 are transmitted to the LCD 17 via the picture quality enhancing engine (HVE) 115 (paths 2A, 2B, 2C, 2D: see FIG. 2). The high quality mode is employed when the moving picture data are displayed on the LCD 17 in the full-screen mode. If still images (desktop screen, operation screen of word processor software, operation screen of a spreadsheet) are subjected to the picture quality correction for the moving pictures, the sharpness becomes too strong and visibility of the still images is degraded.

In a case where the moving picture data are displayed on the LCD 17 in the full-screen mode, if the external devices are used as multi-monitors, the moving picture data can be displayed on the LCD 17 in the high quality mode as described later.

The south bridge 119 controls the devices on an LPC (Low Pin Count) bus. An IDE (Integrated Drive Electronics) controller controlling the HDD 121 and the ODD 122 is built in the south bridge 119. The south bridge 119 comprises a function of controlling the TV tuner 123 and a function of controlling access to the BIOS-ROM 120.

The ODD 123 is a drive unit which drives memory media such as DVD, CD, etc. storing the video contents. The TV tuner 123 is a receiver which receives broadcast program data such as TV broadcast programs.

The embedded controller/keyboard controller IC (EC/KBC) 124 is a one-chip microcomputer in which an embedded controller for power management and a keyboard controller which controls the keyboard (KB) 13 and the touch pad 16 are integrated. The embedded controller/keyboard controller IC (EC/KBC) 124 has a function of controlling power-on/power-off of the computer 10 in accordance with user operations on the power button 14.

Furthermore, the embedded controller/keyboard controller IC (EC/KBC) 124 also has a function of making communications with the picture quality enhancing engine (HVE) 115 via a I²C bus and a function of supplying the switch control signal SW to the switch 118.

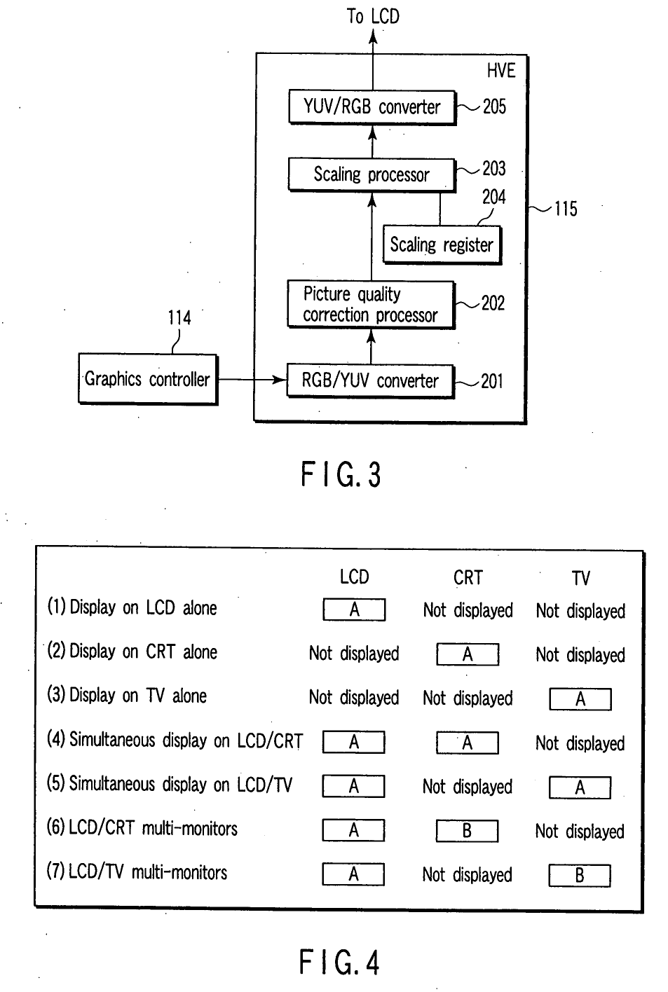

Next, an example of a configuration of the picture quality enhancing engine (HVE) 115 is explained with reference to FIG. 3.

The picture quality enhancing engine (HVE) 115 comprises an RGB/YUV converter 201, a picture quality correction processor 202, a scaling processor 203, a scaling register 204, and a YUV/RGB converter 205 as shown in FIG. 3.

The RGB/YUV converter 201 converts RGB signals of the video signals transmitted from the graphics controller 114 via the TMDS (Rx) processor 116 into YUV signals. The picture quality correction processor 202 executes an operation for picture quality correction (color correction, sharpness correction, brightness correction and edge enhancement) of the YUV signals. The scaling processor 203 scales the quality-corrected YUV signals in accordance with scaling parameter information set in the scaling register 204.

Scaling is a processing for varying the size (resolution) of the moving picture data. The size (resolution) of the moving picture data is varied to a size suitable to the size (panel resolution) of the display screen of the LCD 17 by the scaling. The scaling parameter information includes, for example, the resolution of the moving picture data, the aspect ratio of the moving picture data, and the panel resolution of the LCD 17, etc.

The YUV/RGB converter 205 converts the YUV signals of the scaled picture signals into the RGB signals. The RGB signals are transmitted to the LCD 17.

FIG. 4 shows modes of use of the display device used in the computer 10.

A mode of use (1) of the display device is a mode of use of outputting the picture signals to the LCD 17 alone and not outputting them to the external display devices such as CRT, TV, etc. In this mode of use, the picture signals which is subjected to the picture quality processing by the picture quality enhancing engine (HVE) 115 are output to the LCD 17.

Modes of use (2) and (3) are modes of use of outputting the picture signals to the external display devices, i.e. the CRT alone and the TV alone. In these modes of use, the picture signals generated by the graphics controller 114 are output to the CRT alone or the TV alone, not via the picture quality enhancing engine 115.

Modes of use (4) and (5) are modes of use (dual monitor modes) of urging the LCD 17 and the external display device, i.e. the CRT or the TV to display (clone) the same display contents (the display contents are both “A”). In these modes of use, the picture signals generated by the graphics controller 114 are output to the LCD 17 and the CRT or TV, not via the picture quality enhancing engine 115.

Modes of use (6) and (7) are modes of use (multi-monitor modes) of urging the LCD 17 and the external display device, i.e. the CRT or the TV to display the different display contents (the display contents “A” and “B” are different). In these modes of use, when the pictures are displayed on the LCD 17 in the full-screen mode, the picture signals subjected to the picture quality processing by the picture quality enhancing engine (HVE) 115 are output to the LCD 17 and the picture signals generated by the graphics controller 114 are output to the CRT or TV, not via the picture quality enhancing engine 115.

Information indicating any one of the modes of use (1)-(7) of the display device as explained with reference to FIG. 4 is input to the computer 10 by executing a predetermined operation by the user. When the user executes predetermined key operations with, for example, the keyboard serving as the input means, the information indicating any one of the modes of use (1) to (7) of the display device can be input to the computer 10. The information indicated the selected mode of use of the display device is set, for example, in the register provided in the graphics controller 114.

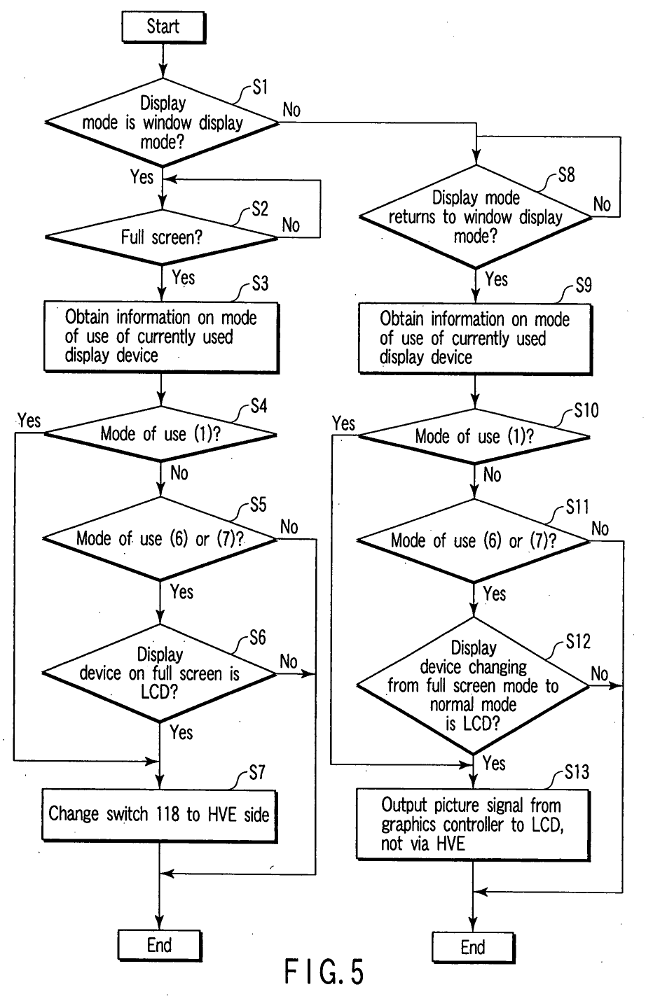

The display control of the display device employed in the computer 10 as explained in FIG. 4 is described in more detail with reference to a flowchart of FIG. 5.

For example, the display driver discriminates whether or not the display mode is the window display mode, in response to the presence or absence of the full-screen mode request from the video reproducing application program for reproducing the moving picture data (block S1).

In this case, the display driver discriminates that the display mode is the full-screen mode, in response to the full-screen mode request issued by the video reproducing application program. On the other hand, if the full-screen mode request is not issued by the video reproducing application program, the display driver discriminates that the display mode is the window display mode. If the display driver discriminates that the display mode is the window display mode (YES in block S1), the display driver discriminates whether or not the display mode becomes the full-screen mode (block S2).

If the display driver discriminates that the display mode becomes the full-screen mode (YES in block S2), the display driver refers to the information on the mode of use of the display device set in the graphics controller 114 as explained with reference to FIG. 4 (block S3).

The display driver discriminates whether or not the mode of use (1) of the display device (i.e. the mode of use of outputting the picture signals to the LCD 17 alone and not outputting them to the external device such as the CRT or TV) is set in the graphics controller 114, by referring to the information indicating the mode of use of the display device stored in the graphics controller 114 (block S4).

If the display driver discriminates that the mode of use (1) of the display device is not set (NO in block S4), the display driver discriminates whether or not the mode of use (6) or (7) of the display device (i.e. the mode of use of urging the LCD 17 and the external device, the CRT or TV to display the different display contents) is set (block S5).

If the display driver discriminates that the mode of use (6) or (7) of the display device is set (YES in block S5), the display driver discriminates whether or not the display device in the full-screen mode is the LCD 17 (block S6).

If the display driver discriminates that the display device in the full-screen mode is the LCD 17 (YES in block S6), the display driver notifies the EC/KBC 124 of the event indicating that the full-screen mode request has been issued, via the system BIOS. The EC/KBC 124 executes the processing of changing the switch 118 to the side of the picture quality enhancing engine (HVE) 115, by the switch control signal SW (block S7).

In addition, if the display driver discriminates in block S4 that the mode of use (1) of the display device is set (YES in block S4), the display driver executes the processing of changing the switch 118 to the side of the picture quality enhancing engine (HVE) 115, in the same manner as that of block S7.

If the display driver discriminates in block S1 that the display mode is not the window display mode, i.e. that the display mode is the full-screen mode (NO in block S1), the display driver discriminates whether or not the display mode becomes the window display mode (block S8).

If the display driver discriminates that the display mode becomes the window display mode (YES in block S8), the display driver refers to the information on the mode of use of the display device stored in the graphics controller 114 as explained with reference to FIG. 4 (block S9).

The display driver refers to the information on the mode of use of the display device stored in the graphics controller 114 and discriminates whether or not the mode of use (1) of the display device (i.e. the mode of use of outputting the picture signals to the LCD 17 alone and not outputting them to the external device such as the CRT or TV) is set in the graphics controller 114 (block S10).

If the display driver discriminates that the information on the mode of use (1) of the display device is not set (NO in block S10), the display driver discriminates whether or not the mode of use (6) or (7) of the display device (i.e. the mode of use of urging the LCD 17 and the external device, the CRT or TV to display the different display contents) is set (block S11).

If the display driver discriminates that the mode of use (6) or (7) of the display device is set (YES in block S11), the display driver discriminates whether or not the display device whose display mode has changed from the full-screen mode to the normal mode is the LCD 17 (block S12).

If the display driver discriminates that the display device whose display mode has changed to the normal mode is the LCD 17 (YES in block S12), the display driver does not notify the EC/KBC 124 of the event indicating that the full-screen mode request has been issued, via the system BIOS, and the picture signals are therefore output from the graphics controller 114 to the LCD 17, not via the picture quality enhancing engine (HVE) 115 (block S13).

If the display driver discriminates in block S10 that the mode of use (1) of the display device is set (YES in block S10), the picture signals are output from the graphics controller 114 to the LCD 17, not via the picture quality enhancing engine (HVE) 115, in the same manner as that of block S13.

In block S S2 and S3 in FIG. 5, the display driver discriminates whether or not the display mode is the full-screen mode, in response to the full-screen mode request issued by the reproducing application. However, the display driver may discriminate whether or not the display mode is the full-screen mode, by discriminating whether or not the size of the moving picture data on the video memory is the Window size.

Thus, even at the multi-monitor time of the LCD and the external display device, the moving pictures can be displayed in the full-screen mode with high quality, on the LCD. In addition, the user can use the high-quality LCD display in the full-screen mode without being particularly conscious of any combination of the display devices.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a built-in display device configured to display picture data on full screen;
a display controller configured to generate a picture signal and output the generated picture signal to an external display device;
picture signal processing means for executing picture quality processing for the picture signal generated by the display controller; and
input means for inputting a mode of allowing the built-in display device to display a first picture and allowing the external display device to display second picture data different from the first picture data,
the built-in display device being a display device configured to display on full screen picture data formed in accordance with the picture signal subjected to picture quality processing by the picture signal processing means if the mode is input by the input means.

2. The apparatus according to claim 1, further comprising second input means for inputting an event of allowing the picture data to be displayed by the display device on full screen,
the display controller being a controller configured to output the generated picture signal to the built-in display device, and
the built-in display device changing the display of the picture data formed in accordance with the picture signal generated by the display controller to the full-screen display of the picture data formed in accordance with the picture signal subjected to the picture quality processing by the picture signal processing means, if the mode is input by the input means and if the event is input by the second input means.

3. The apparatus according to claim 1, further comprising discrimination means for discriminating whether or not the display device displaying the picture data on full screen is the built-in display device,
the built-in display device displaying on full screen the picture data formed in accordance with the picture signal subjected to the picture quality processing by the picture signal processing means, if it is discriminated by the discrimination means that the display device displaying the picture data on full screen is the built-in display device.

4. The apparatus according to claim 1, further comprising second discrimination means for discriminating whether or not the picture data are displayed on the display device on full screen,
the display controller being a controller configured to output the generated picture signal to the built-in display device, and
the built-in display device displaying the picture data formed in accordance with the picture signal generated by the display controller, if the mode is input by the input means and if it is discriminated by the second discrimination means that the picture data are not displayed on full screen on the display device.

5. An information processing apparatus comprising:
a built-in display device configured to display picture data on full screen;
a display controller configured to generate a picture signal and output the generated picture signal to an external display device;
picture signal processing means for executing picture quality processing for the picture signal generated by the display controller; and
input means for inputting a mode of allowing the built-in display device to display a first picture and allowing the external display device to display second picture data different from the first picture data,
the built-in display device being a display device configured to display on full screen picture data formed in accordance with the picture signal subjected to picture quality processing by the picture signal processing means if the mode is input by the input means and if the picture data are displayed on full screen on the built-in display device.

6. The apparatus according to claim 5, further comprising second input means for inputting an event of allowing the picture data to be displayed by the display device on full screen,
the display controller being a controller configured to output the generated picture signal to the built-in display device, and
the built-in display device changing the display of the picture data formed in accordance with the picture signal generated by the display controller to the full-screen display of the picture data formed in accordance with the picture signal subjected to the picture quality processing by the picture signal processing means, if the mode is input by the input means and if the event is input by the second input means.

7. The apparatus according to claim 5, further comprising second discrimination means for discriminating whether or not the picture data are displayed on the display device on full screen,
the display controller being a controller configured to output the generated picture signal to the built-in display device, and
the built-in display device displaying the picture data formed in accordance with the picture signal generated by the display controller, if the mode is input by the input means and if it is discriminated by the second discrimination means that the picture data are not displayed on the display device on full screen.

8. A display control method applied to an information processing apparatus comprising a built-in display device configured to display picture data on full screen, a display controller configured to generate a picture signal and output the generated picture signal to an external display device, and input means for inputting a mode of allowing the built-in display device to display a first picture and allowing the external display device to display second picture data different from the first picture data,
the method comprising:
generating the picture signal by the display controller;
executing picture quality processing for the picture signal generated by the display controller by picture signal processing means; and
displaying on full screen picture data formed in accordance with the picture signal subjected to picture quality processing by the picture signal processing means if the mode is input by the input means and if the picture data are displayed on full screen on the built-in display device.

9. The method according to claim 8, wherein if the mode is input by the input means and if an event of allowing the picture data to be displayed on full screen on the display device, the display of the picture data formed in accordance with the picture signal generated by the display controller, on the built-in display device, is changed to the full-screen display of the picture data formed in accordance with the picture signal subjected to the picture quality processing by the picture signal processing means, on the built-in display device.

10. The method according to claim 8, further comprising discriminating whether or not the display device displaying the picture data on full screen is the built-in display device,
wherein the picture data formed in accordance with the picture signal subjected to the picture quality processing by the picture signal processing means are displayed on full screen on the built-in display device, if it is discriminated that the display device displaying the picture data on full screen is the built-in display device.

11. The method according to claim 8, further comprising discriminating whether or not the picture data are displayed on the display device on full screen,
wherein if the mode is input by the input means and if it is discriminated that the picture data are not displayed on full screen on the display device, the picture data formed in accordance with the picture signal generated by the display controller are displayed on the built-in display device.
